(19) United States
(12) Patent Application Publication
(10) Pub. No.: US 2016/0066076 A1
(43) Pub. Date: Mar. 3, 2016

(54) Ear-Bud Storage

(71) Applicant: Theodore Schatt, Ocala, FL (US)

(72) Inventor: Theodore Schatt, Ocala, FL (US)

(21) Appl. No.: 14/794,090

(22) Filed: Jul. 8, 2015

Related U.S. Application Data
(60) Provisional application No. 62/042,606, filed on Aug. 27, 2014.

(51) Int. Cl. H04R 1/10; B65H 75/24; B65H 75/06

(52) U.S. Cl. CPC H04R 1/1033; B65H 75/06; B65H 75/24

(57) ABSTRACT

A flat elongated storage device of resilient material is configured to be retained on a length of wiring of a conventional portable electronic audio device. The storage device is designed to retain a portion of the wiring, coiled over the storage device, tension in the wiring deforming the storage device to create an open coil. The storage device is narrowed in a midsection portion to allow the desired deformation while maintain the shape of the storage device otherwise.

### BACKGROUND

The present invention pertains to devices for storing elongated electrical wires connecting personal user listening devices to their associated electronics such as personal digital audio devices or cellular telephones and similar devices. The listening devices most often used with handheld electronic audio devices are headphones and miniature speakers often referred to as “ear buds” that are designed to be used on or within the ear. In most cases, these devices are connected to the audio player through fine coated conducting wires. Because these players and listening devices are very small, they are often stored together in a user's garment pocket or other general carrying case. The result is that the wire becomes entangled both with itself and the devices.

What is desired is a device and method for storing connecting wires of portable electronic devices while preventing entanglement and allow easy retrieval from storage.

### SUMMARY OF THE INVENTION

The Invention is a flat elongated storage device of resilient material configured to be retained on a length of wiring of a conventional portable electronic audio or video device or the like. The storage device is designed to retain a portion of the wiring, coiled over and around the storage device, while tension in the wiring deforms the storage device to create an open coil.

In one configuration of the inventive device, the body of the storage device is narrowed in a midsection portion to allow the desired deformation while maintaining the shape of the storage device otherwise. Two apertures in the device are spaced apart and are used to capture the device onto the wiring to be stored. The orientation and relative placement of apertures ensures that the device maintains an aligned configuration. In a preferred embodiment the device has two narrowed portions separated by a wider centrally located circularly shaped region provided to allow for easy handling in use.

The invention includes an improved electronic device having a length of electronic wiring wherein the improvement is a wiring storage device as defined herein. Other aspects of the invention are illustrated in the following description of particular embodiments of the invention and through the accompanying drawing figures.

### DESCRIPTION OF THE DRAWINGS

FIGS. 1 and 2a are plan views of one embodiment of the invention.

FIG. 2b is a side view of the device of FIG. 2a.

FIG. 3 is a plan view of an embodiment of the invention secured to the wiring of a conventional electronic device with electronic wiring connecting microphone earbuds.

FIG. 4 is a plan view of an alternative configuration of the invention.

### DETAILS OF EMBODIMENTS OF THE INVENTION

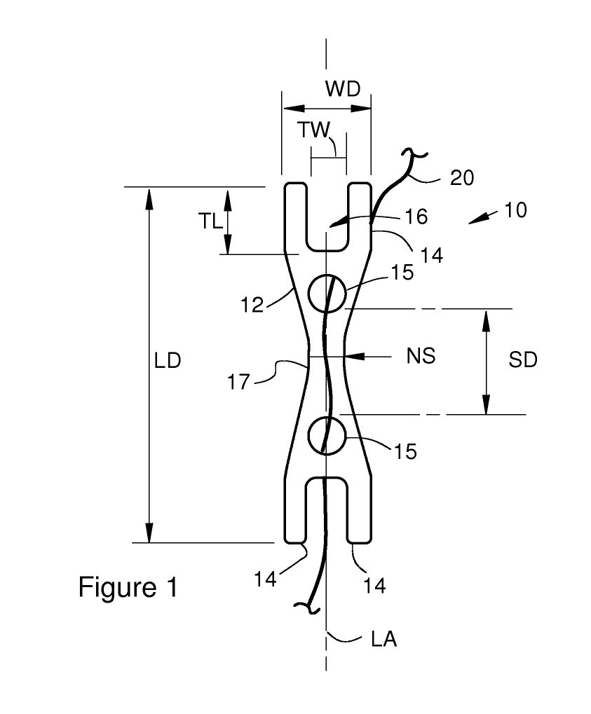

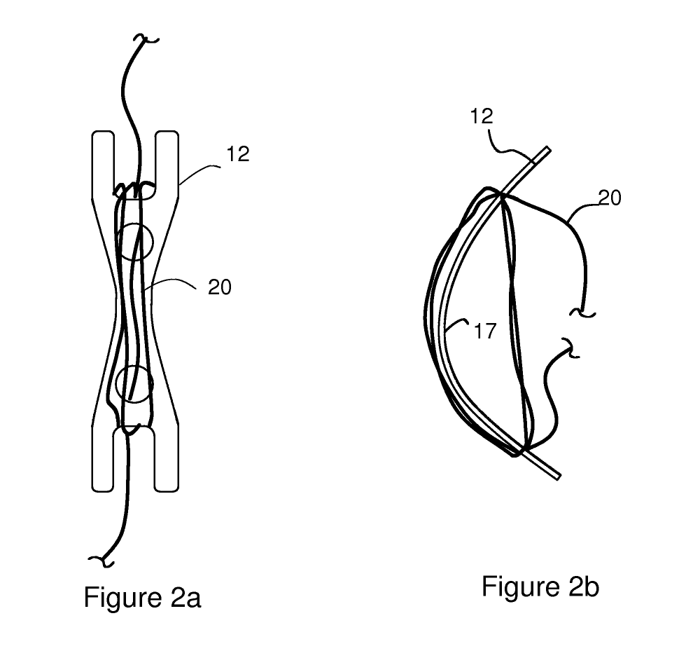

FIGS. 1, 2a, 2b and 3 illustrate a common embodiment of the invention in combination with conductive wiring 20 associated with a portable electronic audio device 40. In FIGS. 1 and 2a, 2b, the wiring 20 is truncated for convenience of illustration. The following discussion applies to all the drawing figures and the structures shown. The inventive wire storage device 10 includes an elongated stiff and resilient body 12. The body 12 is preferably flat and formed of sheet material having a thickness dimension approximately equal to a small fraction of the planar dimensions of the body 12. The minimal thickness is desired to minimize the size and weight of the device for storage purposes. Preferably, the body 12 is formed of a rigid polyvinyl chloride (PVC) material having the proper level of plasticizers added to achieve the flexibility needed, having a thickness of 0.030 inches, or a material having similar properties. The body material may also be a polyethylene thermoplactic having a high strength to density ratio or sheet high density polyethylene (HDPE). The body thickness may be in the range of 0.030 inches to 0.040 inches, depending on the specific material.

The body 12 is generally elongated and has a planar dimension aspect ratio (length to width) of at least three and preferably more than four. This is desired to allow the body 12 to be easily and naturally aligned along the length of the associated wire when the wire is not stored and elongated (see FIG. 1). An aligned storage structure is less likely to be caught on or interfere with other surrounding structures such as a user's clothing.

The body has two terminal ends, each having a pair of extending fingers 14 aligned in mutually parallel fashion. The fingers 14 of each pair are separated from each other to form a storage slot 16. The slot 16 is configured to receive multiple lengths of the wiring 20, the wiring 20 being captured in the form of multiple wiring coils between the two ends as shown in FIG. 2a and over the length of the body 12. Preferably, the slot 16 has a slot length dimension TL, parallel the fingers, of about 0.5 inch. The slot width dimension TW, perpendicular to the length dimension, should be about 0.4 inches, and may have an inward taper to facilitate winding and unwinding of the wiring 20. The above specific dimensions are based on typical devices and wiring found with most conventional current electronic audio devices, and may be altered as required depending at least on the specific application.

As shown in the figures, the fingers 14 of each slot are preferably mutually parallel and also parallel to the long axis of the body 12. However, this relative configuration may be altered and still provide the function desired; each finger may be slightly relatively angled and still form the desired slot 16. Similarly, the fingers 14 need not be completely straight nor of uniform width, as mildly curved or tapered or other alternations may be used while still forming an effective 16. However, particular constructions that do not form a slot that is capable of retaining wiring onto the body 12 during the intended use described should not be attempted and are not within the scope of this invention.

Between the ends of the body, two apertures (through holes) 15 are provided. The function of the apertures 15 is to retain the body 12 on the wiring 20 in an parallel aligned orientation: with the length dimension LD approximately parallel the centerline longitudinal axis LA of the wiring 20 as illustrated in FIG. 1. For this purpose, the wiring 20 is passed through a first aperture in one direction and through the second in an opposite direction. The separation of the apertures 15 and their location on the body centerline retains the body 12 aligned with the wiring 20. For this purpose, the separation dimension SD, between the apertures 15, should be at least 35 to 45 percent (35 to 45%) of the length dimension LD of the body 12. In a preferred configuration, the separation distance SD is in the range of 45 to 55 percent of the length dimension LD.

The body 12 has a narrowed section 17 located middistance between the ends to provide a reduced bending section of the body 12. Preferably, the narrowed section 17 has a reduced width dimension NS equal to no more than about 50 percent of the body width dimension WD.

This configuration allows a user to wrap a portion of the wiring 20 around the body with sufficient tension to induce bending of the body 12 primarily in the narrowed section as seen in the side view of FIG. 2b. The bending of the body 12 at the narrowed section 17 results in an generally oval or otherwise open configuration of the wiring 20 winding with the body 12. This provides a more compact geometric form and easier storage of the device 10 in use, and reduces the potential for entanglement of the wiring 20 when the wiring is subsequently removed from the body 12 for use. By inducing bending through a narrowed section, the remaining portions of the body 12 may be retained sufficiently stiff to provide to maintain shape and therefore assure retention of the wiring. Because the body 12 is formed of resilient material, its shape will be reestablished upon unwinding of the wiring 20 from the body 12, allowing the body to realign with the extended wiring 20.

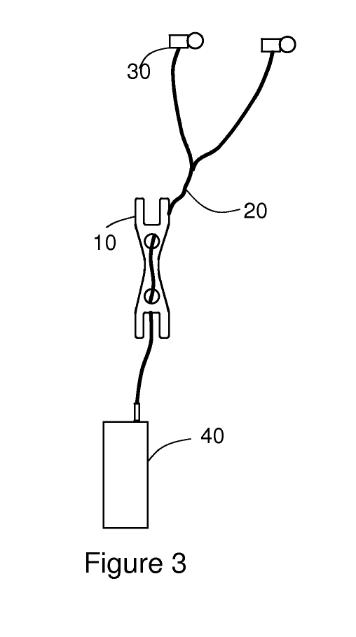

FIG. 3 illustrates the inventive device in combination with a pair of conventional earbuds 30 connected via wiring 20 to a conventional audio device 40. The earbuds 30 are one example of micro-speakers and speakers that may use wiring of a form that may be used in combination with the inventive storage device 10. The audio device may take the form of any of a variety of devices existing and future including digital audio players, analog electronic audio players, digitial audio-video players, portable telephones and other similar devices. The invention includes improved audio players that incorporate the above described storage device.

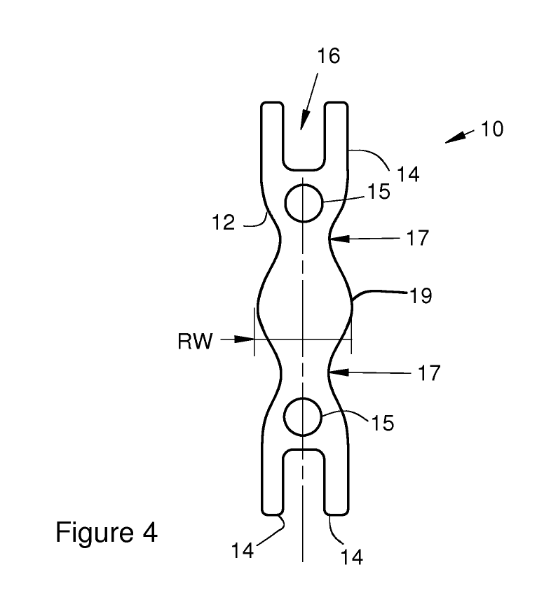

FIG. 4 illustrates an alternative configuration of the inventive device 10. The body 12 of the device includes two narrowed sections 17, that in combination with a centrally located rounded region 19 provides the same function as the single narrowed section 17 in the configuration of FIG. 1. In addition, the generally circular shaped rounded region 19, has a substantially wider rounded width dimension RW than the narrowed sections 17, to provide easier handling for the user. The rounded width dimension should be about equal the width dimension WD. In other aspects, the configuration of FIG. 4 shares the design features of that of FIG. 1 discussed above.

Other alternative configurations and materials may be employed while maintaining the inventive aspects illustrated above and through the accompanying figures.

1. A storage device for retaining a length of personal electronic device wiring comprising:
a flat elongated body having a long axis, the body comprising a resilient sheet material;
the body further comprising:
a first and second terminal end, each end having a pair of fingers forming a slot, each finger extending substantially parallel to the long axis;
a first tapered reduced width portion between the first and second ends; and
a first and second aperture, each located on the long axis and mutually separated by a separation dimension sufficient, when a length of the electronic device wiring is threaded through both, to retain the body long axis substantially parallel to the wiring.

2. A device, according to claim 1, and wherein:
the body has a body width dimension at the terminal ends; and
the first reduced width portion has a reduced width dimension equal to no more than 50 percent of the body width dimension.

3. A device, according to claim 2, and further comprising:
a second tapered reduced width portion between the first and second ends;
a rounded portion located between the first and second reduced width portion, the rounded portion having a rounded width greater than reduced width dimension.

4. A device, according to claim 3, and wherein:
the body has an overall body length dimension; and
the separation dimension is at least 35 percent of the body length dimension.

5. A device, according to claim 4, and wherein:
the body length dimension divided by the body with dimension is a ratio of at least three.

6. A device, according to claim 3, and wherein:
the slot has a depth dimension, parallel to the long axis, of 1/2 inch.

7. A device, according to claim 3, and wherein:
the sheet material comprises polyvinyl chloride having a thickness in the range of 0.030 inches and 0.040 inches.

8. An improved electronic device having an elongated electronic wiring, wherein the improvement comprises:
the device of claim 1.
